(19) United States
(12) Patent Application Publication
(10) Pub. No.: US 2019/0162618 A1
(43) Pub. Date: May 30, 2019

(54) VACUUM MONITOR

(71) Applicant: HORIBA STEC, Co., Ltd., Kyoto-shi (JP)

(72) Inventors: Sotaro Kishida, Kyoto-shi (JP); Keisuke Yamashita, Kyoto-shi (JP); Junya Nakai, Kyoto-shi (JP)

(21) Appl. No.: 16/201,954

(22) Filed: Nov. 27, 2018

(30) Foreign Application Priority Data
Nov. 29, 2017 (JP) 2017-229399

(51) Int. Cl. G01L 19/14; G01L 21/12; G01L 9/12; G01L 9/00

(52) U.S. Cl. CPC G01L 19/14; G01L 9/0072; G01L 9/125; G01L 21/12

(57) ABSTRACT

In order to provide a vacuum monitor that, even if a sensing mechanism is exposed to an atmosphere into which various types of material gases are introduced, enables the deposition of matter on the sensing mechanism to be prevented, and enables the lifespan of the sensing mechanism to be extended, there are provided a sensing mechanism that is in contact with an atmosphere inside a measurement space, and outputs an output signal that corresponds to a pressure inside this measurement space, and a heater that adjusts a temperature of the sensing mechanism, wherein a set temperature of the heater is adjustable.

### TECHNICAL FIELD

The present invention relates to a vacuum monitor.

### TECHNICAL BACKGROUND

For example, in a semiconductor manufacturing process, a vacuum monitor that is used to monitor a degree of vacuum is provided inside a vacuum chamber where film formation is performed. As is shown in Patent document 1, a vacuum monitor is provided with a sensing mechanism that is exposed to the atmosphere inside a vacuum chamber, and with a pressure calculation circuit into which is input an output signal which is output from the sensing mechanism in accordance with the pressure, and that converts this output signal into a pressure signal which shows the pressure.

In recent years, in conjunction with the increasing miniaturization required in semiconductor manufacturing processing, an increasing variety of diverse material gases are being introduced into the vacuum chamber, and among these new material gases are those whose condensation temperature is far higher than that of conventional material gases.

Because of this, the problem arises that a portion of the material gases that tend to condense easily becomes condensed on the sensing mechanism, and components thereof become deposited thereon so that the sensitivity of the sensing mechanism towards pressure is reduced, and the lifespan thereof as a sensor is shortened. If deposits are generated on the sensing mechanism, then it is necessary for the entire vacuum monitor to be extracted from the vacuum chamber and replaced, so that considerable time is required to change the set-up and perform calibration, which greatly prolongs the semiconductor manufacturing processing downtime, and leads to a deterioration in throughput.

Moreover, if the temperature of the material gases is raised in order to prevent condensation, then there are cases when decomposition occurs and it is not possible to achieve film formation using the intended components. Accordingly, the situation currently is that, if a plurality of different types of material gases are to be introduced into a vacuum chamber, then individual vacuum monitors are prepared in accordance with the characteristics of the material gases.

### DOCUMENTS OF THE PRIOR ART

### Patent Documents

Patent document 1 Japanese Patent No. 4437578

### DISCLOSURE OF THE INVENTION

### Problems to be Solved by the Invention

The present invention was conceived with the intention of solving the above-described problems, and it is an object thereof to provide a vacuum monitor that, even if a sensing mechanism is exposed to an atmosphere into which various types of material gases are introduced, enables the deposition of matter on the sensing mechanism to be prevented, and thereby enables the lifespan of the sensing mechanism to be extended.

### Means for Solving the Problem

A vacuum monitor according to the present invention is provided with a sensing mechanism that is in contact with an atmosphere inside a measurement space, and outputs an output signal that corresponds to a pressure inside this measurement space, and a heater that adjusts a temperature of the sensing mechanism, wherein a set temperature of the heater is adjustable.

By employing this type of structure, it is possible, for example, in accordance with a condensation temperature and a decomposition temperature of gases present within a measurement space, to maintain a temperature at which condensation of the gases in a sensing mechanism does not occur, and even if various types of gases are introduced into the measurement space, it is possible to prevent components in the gases from being deposited on the sensing mechanism.

Accordingly, because the sensitivity of a vacuum monitor can be maintained over a prolonged period so that the lifespan of the vacuum monitor can be extended, it becomes possible to reduce the frequency at which downtimes occur in, for example, a semiconductor manufacturing process, and to consequently improve throughput.

In order to enable temperature control of the heater to be performed exclusively inside the vacuum monitor without a temperature control signal that is used to control the temperature of the heater needing to be received from outside the vacuum monitor, so that structure such as wiring and the like can be simplified, it is also possible for there to be provided a sensor module that is equipped with the sensing mechanism, and a main body module that is equipped with a pressure calculation circuit into which output signals from the sensing mechanism are input and that calculates pressure values, and with a heater control circuit that controls a temperature of the heater, wherein the heater control circuit controls the current or the voltage of the heater such that the temperature of the heater remains at an input set temperature.

Even when it is possible to adequately adjust the temperature of the sensing mechanism, gas components are still deposited thereon even if only in miniscule quantities, so that eventually it becomes necessary to replace the vacuum monitor. In such cases as this as well, in order to make it possible to replace just part of a faulty sensing mechanism instead of having to replace the entire sensing mechanism, and to thereby, for example, enable downtimes in a semiconductor manufacturing process to be reduced to a minimum, it is also possible for the sensor module to be removably attached to the main body module.

In a conventional vacuum monitor in which the sensor module is unable to be separated from the main body module and cannot be removably attached thereto, when the lifespan of the vacuum monitor reaches its end, it has often been necessary to replace the entire vacuum monitor and then, for example, calibrate the new vacuum monitor in the field. Because of this, the problem has existed that, for example, the semiconductor manufacturing processing downtime was extended by the length of time required for the calibration processing. In order to shorten or eliminate the time required for this type of calibration processing, and to make it possible to obtain accurate pressure values immediately after replacing the sensor module so as to enable the downtime to be shortened accordingly, it is also possible for the pressure calculation circuit to be provided with a calibration data storage unit in which calibration data corresponding to the sensing mechanism is stored, and with a pressure calculation unit that calculates pressure values based on output signals from the sensing mechanism and on the calibration data, wherein the calibration data storage unit is formed such that the calibration data can be updated via an external input. By employing this type of structure, it is possible, for example, for calibration processing to be performed in advance for each sensor module at the vacuum pump place of manufacture. If this calibration data is then sold together with the sensor module, then simply by writing new calibration data that corresponds to the new sensor module in the calibration data storage unit when the replacement work is being performed, accurate pressure values can be obtained immediately.

In cases in which the set temperature of the heater is appropriately altered due to a variety of different types of gas being introduced into the measurement space, in order to prevent the accuracy of the pressure values calculated by the pressure calculation circuit from being impaired due to these differences in temperature, it is also possible for the pressure calculation circuit to be further provided with a correction coefficient storage unit in which correction coefficients that correspond to the set temperature of the heater are stored, and with a correction unit that, based on the correction coefficients, corrects pressure values calculated by the pressure calculation unit.

In cases in which the heater must be kept at a high temperature in order to prevent components in a gas from being deposited on the sensing mechanism, in order to ensure that the pressure calculation circuit does not malfunction or fail due to the effects of such heat, it is also possible for there to be further provided a thermal insulation module that separates the sensor module and the main body module from each other by a predetermined distance, and prevents heat generated in the sensor module from being transferred to the main body module.

When a new sensor module has been attached to the main body module, in order to reliably prevent situations such as a shift occurring in the position of the heater relative to the sensing mechanism so that a desired temperature adjustment mode can no longer be implemented, and to thereby enable ideal temperature adjustment to be continually maintained, it is also possible for the sensor module to be formed so as to be able to be removably attached to the main body module with the sensing mechanism and the heater being formed as an integrated body.

In cases in which a plurality of lines are required in order for signals to be exchanged between the main body module and the sensor module, in order to enable the sensor module to be easily attached to the main body module without being affected by discrepancies between the dimensions of the respective components or by positional discrepancies or the like, it is also possible for the main body module to be further equipped with a heater control circuit that controls the temperature of the heater, and for a main connector that connects the sensing mechanism to the pressure calculation circuit, and a sub-connector that connects the heater to the heater control circuit to be provided in the thermal insulation module, and for at least one of the main connector and the sub-connector to be flexible.

In cases in which there is a considerable distance separating the main body module from the sensor module so that noise from the outside is able to easily enter the main connector, in order to make it difficult for the effects of such noise to be superimposed on the output signal from the sensing mechanism and enable accurate pressure values to be obtained, it is also possible for the main connector to be provided with a central conductor along which the output signals from the sensing mechanism are transmitted, a cylindrical insulating body that covers a side circumferential surface of the central conductor and is electrically insulated, and an outer conductive body that covers an outer-side circumferential surface of the insulating body, wherein a cylindrical connector socket that is formed by a conductive body and covers an outer side of the outer conductive body is provided in the thermal insulation module.

### Effects of the Invention

In this way, according to the vacuum monitor according to the present invention, because the set temperature of the heater that adjusts the temperature of the sensing mechanism is adjustable, in cases in which various different types of gas are introduced into a measurement space, it is possible to set a temperature that corresponds to the types of gas, and prevent components in the gases from being deposited on the sensing mechanism. Accordingly, in cases in which material gases that are easily condensed are used, for example, in conjunction with the increasing miniaturization in semiconductor manufacturing processing, it is possible to prevent the lifespan of the vacuum monitor from being shortened, and it becomes possible to reduce the frequency at which downtimes occur in a semiconductor manufacturing process.

### BRIEF DESCRIPTION OF THE DRAWINGS

FIG. 1 is a typical perspective view showing a vacuum monitor according to an embodiment of the present invention.

FIG. 2 is a typical cross-sectional view showing the vacuum monitor in the same embodiment.

FIG. 3 is a typical perspective view showing a state in which a sensor module of the vacuum monitor has been removed in the same embodiment.

FIG. 4 is a typical cross-sectional view showing a state in which the sensor module of the vacuum monitor has been removed in the same embodiment.

FIG. 5 is a typical cross-sectional view showing a main connector of the vacuum monitor in the same embodiment.

FIG. 6 is a function block diagram showing each function of the vacuum monitor in the same embodiment.

FIG. 7 is a typical cross-sectional view of the main connector in the same embodiment.

### BEST EMBODIMENTS FOR IMPLEMENTING THE INVENTION

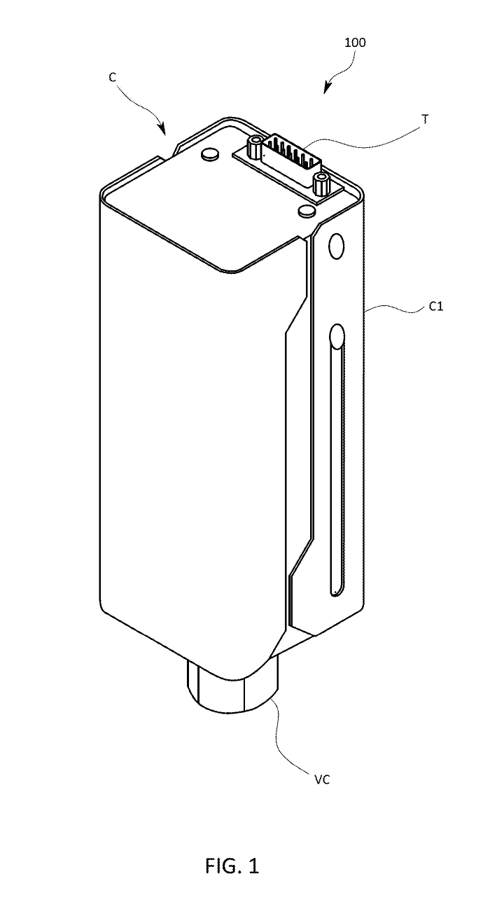

A vacuum monitor 100 according to an embodiment of the present invention will now be described with reference to FIG. 1 through FIG. 7.

The vacuum monitor 100 of the present embodiment is used, for example, in order to monitor a degree of vacuum inside a vacuum chamber which is a measurement space where film formation and the like are performed in a semiconductor manufacturing process. The vacuum monitor 100 is provided on an outer side of a partitioning wall of the vacuum chamber, and is connected so as to be able to communicate with an interior portion of the vacuum chamber.

As is shown in FIG. 1, the pressure gauge 100 has a substantially parallelepiped-shaped configuration and has a vacuum coupling VC provided at a distal end portion thereof, and an output terminal T that is used to output measured pressure values to the outside provided at a base end portion thereof.

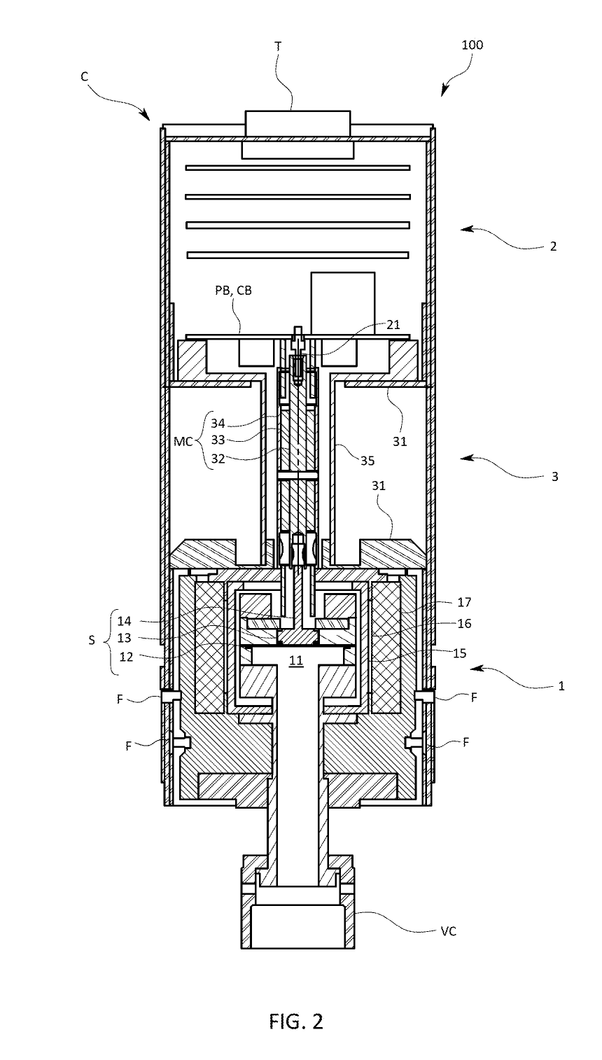

As is shown in cross-sectional view in FIG. 2, in the vacuum monitor 100, three modules are housed or formed inside a casing C. In other words, these three modules are in the form of a sensor module 1 that communicates with an atmosphere inside a vacuum chamber that is housed on the base end side of the casing C, a main body module 2 that is formed on the distal end side of the casing C, and in which are housed circuits and the like that process output signals from the sensor module 1, or control the sensor module 1, and a thermal insulation module 3 that forms an intermediate portion of the casing C and is formed between the sensor module 1 and the main body module 2, and that prevents heat generated in the sensor module 1 from being transferred to the main body module 2.

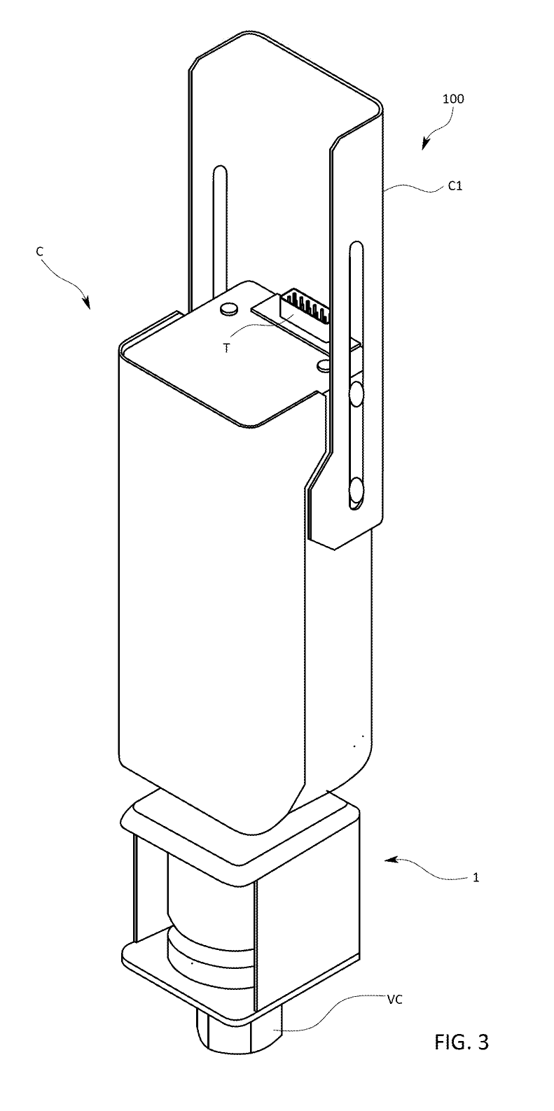

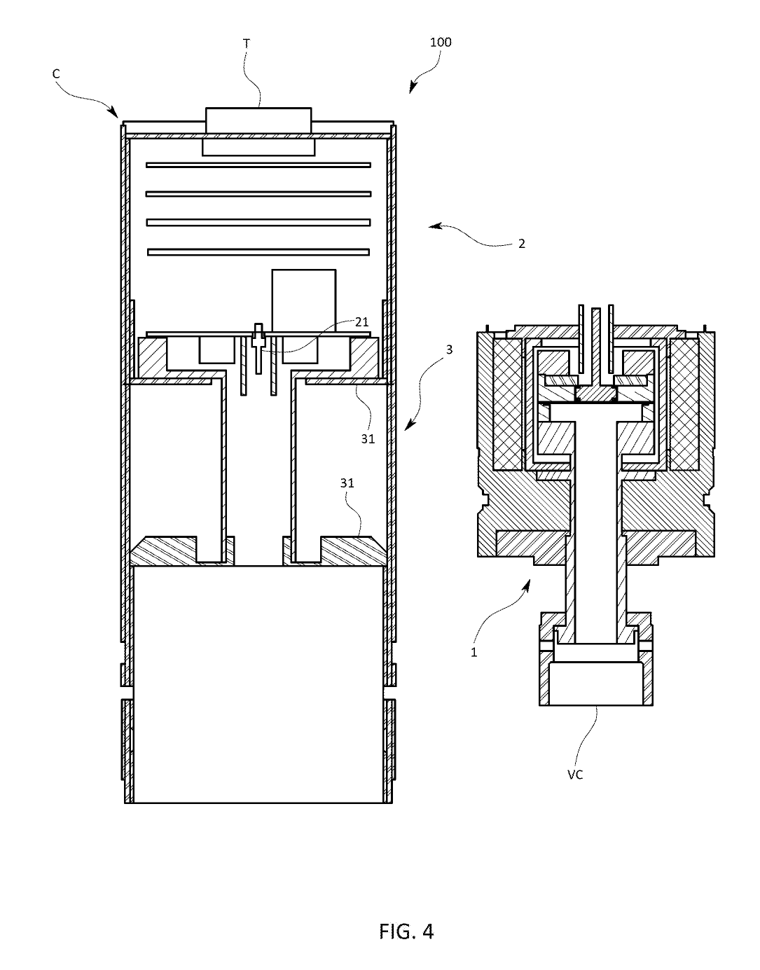

In the vacuum monitor 100 of the present embodiment, a structure is employed in which the sensor module 1 is able to be removably attached to the main body module 2 and the thermal insulation module 3. More specifically, as is shown in FIG. 3, a structure is employed in which a cover C1, which forms one side surface of the casing C, is able to perform a sliding motion in the longitudinal direction of the casing C, so that, as is shown in the cross-sectional view in FIG. 4, the connection between the sensor module 1 and the main body module 2 is released and the sensor module 1 can be removed from the inside the casing C. Conversely, it is also possible, when the casing C is open, to house the sensor module 1 inside the casing C and attach it to the main body module 2. As is shown in FIG. 2, the position of the main body module 2 is fixed inside the casing C as a result of a side surface of the main body module 2 being press-fixed via fixing components F such as screws or the like from the casing C. Conversely, by removing these fixing components F, the sensor module 1 can be extracted from inside the casing C. An upper surface side of the sensor module 1 is connected to the main body module 2 via a removable main connector MC that is provided inside the thermal insulation module 3.

The respective modules will now be described in detail.

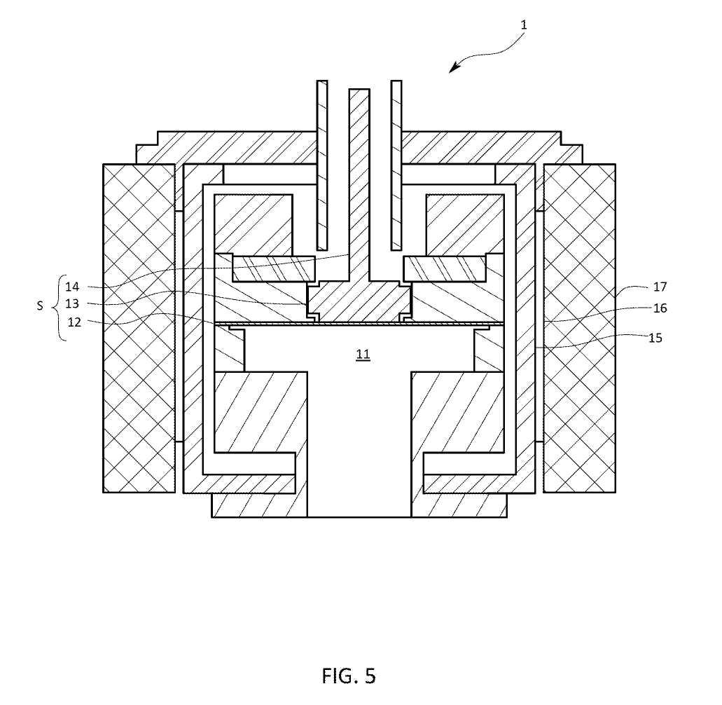

As is shown in FIG. 2 and in a cross-sectional enlargement in FIG. 5, the sensor module 1 is provided with the vacuum coupling VC that is attached to the vacuum chamber, a sensing mechanism S of which a portion is exposed to the atmosphere inside the vacuum chamber, and a heater 16 that is provided around a periphery of the sensing mechanism S.

The sensing mechanism S is a diaphragm type of electrostatic capacitance form of pressure detecting mechanism, and is provided with an intake space 11 into which the atmosphere inside the vacuum chamber is introduced through the vacuum coupling VC, a diaphragm 12 that provides a partition between a reference pressure such as, for example, atmospheric pressure and the vacuum chamber, a detection electrode 13 that is provided so as to face a central portion of the diaphragm 12, and an output electrode 14 that is used to output an electric potential of the detection electrode 13 as an output signal to the main body module 2.

The diaphragm 12 is a circular plate-shaped thin membrane and is supported by an outer circumferential portion thereof being clamped by a clamping body. The diaphragm 12 is formed such that when there is a change in the pressure inside the vacuum chamber, a deformation is generated in the membrane by the pressure difference between the two surfaces of the diaphragm 12. Components of a material gas that is introduced into the vacuum chamber also flow into the intake space 11 side of the diaphragm 12, and there is a possibility that this gas will also become adhered, condensed and deposited.

A slight gap is formed between the detection electrode 13 and the diaphragm 12, and when the diaphragm 12 is deformed, this deformation generates a change in the separation distance between a detection surface of the detection electrode 13 and the central portion of the diaphragm 12. The detection electrode 13 detects a change in the electrostatic capacitance which is caused by this change in the separation distance as a change in the electric potential.

The sensing mechanism S is housed inside a metal housing body 15 having a substantially cubic shape, and the heater 16 is provided on an outer side surface of this housing body 15. More specifically, the heater 16 is, for example, a film heater 16, and is wound around the housing body 15 in a thin circular cylinder-shaped configuration so that the set temperature thereof can be altered via the amount of voltage or the amount of current that is applied thereto. As is shown in FIG. 5, the heater 16 is disposed such that, if the diaphragm 12 is located at the center thereof, the heater 16 extends towards the distal end side and the base end side, and is principally intended to maintain the temperature of the diaphragm 12 at a desired temperature. Additionally, an insulator 17 that provides thermal insulation is disposed on the outer circumferential side of the heater 16.

In the present embodiment, the sensing mechanism S and the heater 16 are integrated into a single body so as to form the sensor module 1. If deposits are generated on the sensing mechanism S so that the replacement thereof becomes necessary, the heater 16 is replaced together with the sensing mechanism S.

The main body module 2 is equipped with a pressure calculation circuit PB that calculates pressure values based on output signals from the sensing mechanism S, and a heater control circuit CB that governs the supply of power to the heater 16 as well as the control thereof.

The pressure calculation circuit PB and the heater control circuit CB are equipped with what is known as a microcomputer that is provided with a CPU, memory, and input/output devices such as an A/D converter and a D/A converter and the like. When a program stored in the memory is executed, the various devices operate in mutual collaboration and perform the functions of the pressure calculation circuit PB and the heater control circuit CB.

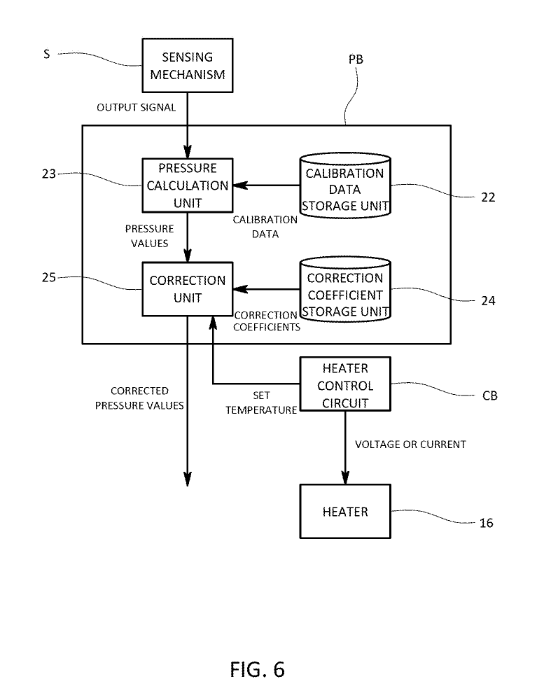

As is shown in FIG. 6, the pressure calculation circuit PB is formed so as to perform the functions of at least a calibration data storage unit 22, a pressure calculation unit 23, a correction coefficient storage unit 24, and a correction unit 25.

The calibration data storage unit 22 stores calibration data that shows characteristics of the sensing mechanism S that is currently connected. The calibration data may be in the form, for example, of a calibration curve showing a relationship between voltage values shown by output signals from the sensing mechanism S, and the pressure values. This calibration data is formed such that it can be rewritten by means of an external input. In other words, when the sensor module 1 has been replaced, the existing calibration data is rewritten with individual calibration data corresponding to the new sensor module 1, so that the pressure calculation circuit PB is able to calculate accurate pressure values. The calibration data may be prepared by performing calibration in the vacuum chamber in which the vacuum monitor 100 is provided, however, it is preferable for calibration to be performed at the place of manufacture when the sensor module 1 is being inspected and the like prior to shipping, and for the calibration data consequently obtained as well as the relevant sensor module 1 to both be offered together. By employing this system, even if calibration processing is not performed at the time when the sensor module 1 is replaced, simply by overwriting the calibration data stored in the calibration data storage unit 22 with calibration data corresponding to the new sensor module 1, accurate pressure values can be immediately obtained.

The pressure calculation unit 23 calculates pressure values based on voltage values shown by the output signals from the sensing mechanism S, and on the calibration data stored in the calibration data storage unit 22.

The correction coefficient storage unit 24 stores correction coefficients that correspond to the set temperature of the heater 16. In other words, the correction coefficients are matched to the fact that the amount of deformation changes depending on the temperature of the diaphragm 12, and are used to ensure that correct pressure values are output. For example, the correction coefficient storage unit 24 stores correction coefficients that correspond to each set temperature in a table form.

The correction unit 25 corrects the pressure values calculated by the pressure calculation unit 23 based on the correction coefficients. More specifically, the correction unit 25 refers to the set temperature set in the heater 16, and then reads the correction coefficient that corresponds to that set temperature from the correction coefficient storage unit 24. The correction unit 25 then calculates corrected pressure values by multiplying the read correction coefficient by the pressure values output from the pressure calculation circuit PB.

The heater control unit CB receives a set temperature via, for example, an external input from a user, and performs feedback control on the voltage value or the current value applied to the heater 16 such that this set temperature is attained. In the present embodiment, the range of the set temperature received by the control unit of the heater 16 is set to not less than 100° C. and not more than 300° C. This is set in accordance with the range of condensation temperatures of material gases that have a possibility of being introduced into the vacuum chamber. In other words, a user is able to select an appropriate temperature that will prevent condensation and decomposition from occurring in accordance with the type of material gas to be introduced into the vacuum chamber, and set this as the set temperature. The heater control circuit CB controls the current or voltage applied to the heater 16 by, for example, performing temperature feedback control such that any deviation between the measurement temperature as measured by a temperature sensor such as a thermistor or the like that is provided within the sensor module 1 and the set temperature is minimized.

Lastly, the thermal insulation module 3 will be described. As is shown in FIG. 2, the thermal insulation module 3 has a space that separates the sensor module 1 from the main body module 2 by a predetermined distance, and also provides thermal insulation. In this thermal insulation module 3, thermal insulation material 31 is also disposed in the boundary portion between the sensor module 1 and the main body module 2, and this makes it difficult for heat generated by the heater 16 inside the sensor module 1 to be transferred to the main body module 2. The separation distance between the sensor module 1 and the thermal insulation module 3 is formed such that, for example, even if the set temperature in the heater 16 is set to the maximum temperature thereof, the temperature of the main body module 2 is only raised by the heat from the heater 16 to a temperature that does not cause the pressure calculation circuit PB and the heater control circuit CB within the main body module 2 to malfunction or to fail.

Because this thermal insulation module 3 is provided and the sensor module 1 and the main body module 2 are mutually separated from each other, in order to enable signals to be transmitted and received and power to be supplied, a plurality of connectors that connect the sensor module 1 and the main body module 2 together are provided in the thermal insulation module 3.

More specifically, a main connector MC that is provided in a central portion of the thermal insulation module 3 and that connects the sensing mechanism S and the pressure calculation circuit PB together, and a sub-connector (not shown in the drawings) that connects the heater 16 and the heater control circuit CB together are provided.

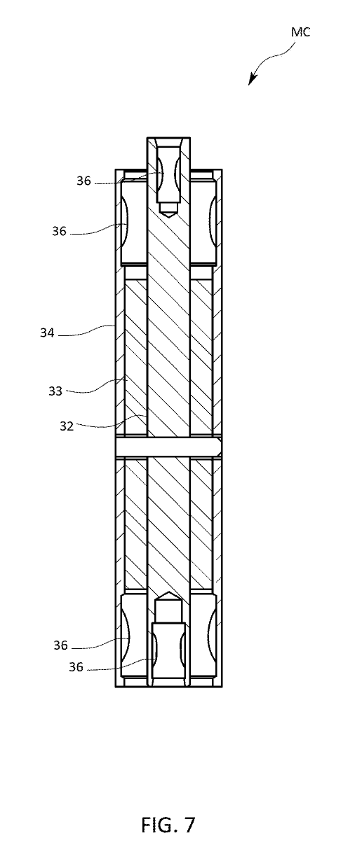

As is shown in an enlarged view in FIG. 7, the main connector MC is provided with a central conductor 32 along which the output signal from the sensing mechanism S is transmitted, a cylindrical insulating body 33 that covers a side circumferential surface of the central conductor 32 and is electrically insulated, and an outer conductive body 34 that covers an outer-side circumferential surface of the insulating body 33. Additionally, contact springs 36 that apply pressure in a radial direction when the output electrode 14 of the sensing mechanism S or the input terminal 21 of the power calculation circuit PB are plugged in are provided at each end portion of the main connector MC. End portions of the main connector MC are also engaged with a circular cylinder-shaped shield that covers the respective peripheries of both the output electrode 14 of the sensing mechanism S and the input terminal of the power calculation circuit PB, and these portions are also pressed inwards in the radial direction by the contact springs 36. Resistance is generated by the respective contact springs 36 when the output electrode 14 and the input terminal 21 have been sufficiently plugged in so that, when the sensor module 1 has been replaced, it is possible to confirm, without having to make a visual inspection thereof, that the sensor module 1 has been properly connected to the output calculation circuit PB of the main body module 2 via the main connector MC.

A connector socket 35 that is formed by a conductive body in a circular cylinder shape and covers the periphery of the main contact MC is further provided in the thermal insulation module 3. This connector socket 35 is fixed inside the thermal insulation module 3, and is grounded so as to have an earth potential. In other words, the central conductor 32 of the main connector MC has a double shield in the form of the outer conductive body 34 and the connector socket 35. Because of this, even when the sensing mechanism S and the pressure calculation circuit PB are mutually separated from each other, it is possible to suppress noise from being superimposed on the output signal from the sensing mechanism S, and enable accurate pressure values to be obtained easily.

Unlike the main connector MC, the sub-connector is a flexible cord, and connects the heater 16 and the heater control circuit CB together. By employing this type of structure, the sensor module 1 and the main body module 2 can be easily connected together even if the positional accuracy of the respective terminals is not strictly managed.

According to the vacuum monitor 100 of the present embodiment which is formed in the above-described manner, because the set temperature of the heater 16 which adjusts the temperature of the sensing mechanism S is adjustable, it is possible to adjust the temperature of the sensing mechanism S to a temperature that corresponds to the various different types of gases within a vacuum chamber. Accordingly, by adjusting the temperature of the sensing mechanism S to an optimum temperature in accordance with the condensation temperature and decomposition temperature of the material gases, it is possible to prevent the deposition of components that is caused by condensation of the material gases on the diaphragm 12 of the sensing mechanism S without this having any effect on the film formation and the like being performed in the vacuum chamber.

Because of this, due to the increasing miniaturization of semiconductor manufacturing processing, even if material gases and the like that have not hitherto been used are used, it is still possible to prolong the lifespan of the sensing mechanism S, to reduce the frequency at which downtimes occur, and to improve throughput.

Moreover, even if tiny amounts of deposition on the sensing mechanism S have progressed gradually over time so that, ultimately, the lifespan of the sensing mechanism S is shortened, by simply treating the sensor module 1 as an expendable item and replacing only the sensor module 1 while leaving the main body module 2 in position, pressure measurement can be recommenced immediately. At this time, by overwriting the calibration data stored in the calibration data storage unit 22 with calibration data corresponding to the new sensor module 1 at the same time as the sensor module 1 is replaced, it is possible to avoid having to perform calibration processing when the replacement is made.

Accordingly, it is possible to greatly curtail the time required between the replacement of the sensor module 1 and the recommencement of pressure measurement compared to the conventional technology, so that the length of the actual downtime itself can also be shortened.

Other embodiments will now be described.

In the above-described embodiment, a thermal insulation module is provided in order to separate the sensor module from the main body module by a predetermined distance, however, provided that it is possible, for example, to sufficiently block the heat generated in the sensor module from being transferred to the main body module, then the thermal insulation module may be omitted. In other words, it is also possible for the sensor module and the main body module to be placed mutually adjacent to each other.

The sensor module is formed such that it can be removably attached to the main body module, however, in applications in which, for example, it is essentially unnecessary for the sensor module to be replaced because of heat from the heater, then it is also possible for the main body module and the sensor module to be formed as a single integrated body that is unable to be separated. In this case, it is sufficient for at least the set temperature of the heater to be adjustable.

The sensing mechanism is not restricted to being a diaphragm type of pressure detection mechanism. For example, an ionization type of pressure detection mechanism may also be used, alternatively, a person who detects pressure based on a relationship between the pressure and the vibration frequency of a structural body may also be employed.

The measurement space where the vacuum monitor is used is not limited to being a vacuum chamber where film formation is performed, and some other type of space may be employed as the measurement space.

Furthermore, various modifications of the above-described embodiment, and combinations of portions of the above-described embodiment may also be made insofar as they do not depart from the spirit or scope of the present invention.

### DESCRIPTION OF THE REFERENCE CHARACTERS

100 . . . Vacuum monitor
1 . . . Sensor module
11 . . . Intake space
12 . . . Diaphragm
13 . . . Detection electrode
14 . . . Output electrode
15 . . . Housing body
16 . . . Heater
17 . . . Insulator
2 . . . Main body module
22 . . . Calibration data storage unit
23 . . . Pressure calculation unit
24 . . . Correction coefficient storage unit
25 . . . Correction unit
PB . . . Pressure calculation circuit
CB . . . Heater control circuit
3 . . . Thermal insulation module
31 . . . Thermal insulation material
32 . . . Central conductor
33 . . . Insulating body
34 . . . Outer conductive body
35 . . . Connector socket
36 . . . Contact spring
MC . . . Main connector

What is claimed is:

1. A vacuum monitor comprising:
a sensing mechanism that is in contact with an atmosphere inside a measurement space, and outputs an output signal that corresponds to a pressure inside this measurement space; and
a heater that adjusts a temperature of the sensing mechanism, wherein
a set temperature of the heater is adjustable.

2. The vacuum monitor according to claim 1, comprising:
a sensor module that is equipped with the sensing mechanism; and
a main body module that is equipped with a pressure calculation circuit into which output signals from the sensing mechanism are input and that calculates pressure values, and a heater control circuit that controls a temperature of the heater, wherein
the heater control circuit controls the current or the voltage of the heater such that the temperature of the heater remains at an input set temperature.

3. The vacuum monitor according to claim 1, wherein the sensor module is removably attached to the main body module.

4. The vacuum monitor according to claim 3, wherein the pressure calculation circuit comprises:
a calibration data storage unit in which calibration data corresponding to the sensing mechanism is stored; and
a pressure calculation unit that calculates pressure values based on output signals from the sensing mechanism and on the calibration data, wherein
the calibration data storage unit is formed such that the calibration data can be updated via an external input.

5. The vacuum monitor according to claim 4, wherein
the pressure calculation circuit further comprises:
a correction coefficient storage unit in which correction coefficients that correspond to the set temperature of the heater are stored; and
a correction unit that, based on the correction coefficients, corrects pressure values calculated by the pressure calculation unit.

6. The vacuum monitor according to claim 2, further comprising a thermal insulation module that separates the sensor module and the main body module from each other by a predetermined distance, and prevents heat generated in the sensor module from being transferred to the main body module.

7. The vacuum monitor according to claim 2, wherein the sensor module further comprises the heater, and
the sensor module is formed so as to be able to be removably attached to the main body module with the sensing mechanism and the heater being formed as an integrated body.

8. The vacuum monitor according to claim 6, wherein the thermal insulation module comprises:
a main connector that connects the sensing mechanism to the pressure calculation circuit; and
a sub-connector that connects the heater to the heater control circuit, and wherein at least one of the main connector or the sub-connector are flexible.

9. The vacuum monitor according to claim 8, wherein
the main connector comprises:
a central conductor along which the output signals from the sensing mechanism are transmitted;
a cylindrical insulating body that covers a side circumferential surface of the central conductor and is electrically insulated; and
an outer conductive body that covers an outer-side circumferential surface of the insulating body, wherein
a connector socket that is formed by a cylindrical conductive body and covers an outer side of the outer conductive body is provided in the thermal insulation module.
